(19) United States
(12) Patent Application Publication
(10) Pub. No.: US 2026/0113307 A1
(43) Pub. Date: Apr. 23, 2026

(54) SOUNDLESS SPEECH RECOGNITION METHOD, SYSTEM AND DEVICE

(71) Applicant: TEPY PTY LTD, Leichhardt, New South Wales (AU)

(72) Inventors: Jason Robert POTAS, Kingsford (AU); Chris Julian ZAHARIA, Forest Lodge (AU)

(21) Appl. No.: 19/117,951

(22) PCT Filed: Oct. 4, 2023
(86) PCT No.: PCT/AU2023/050955

§ 371 Date: Apr. 2, 2025

(30) Foreign Application Priority Data
Oct. 5, 2022 (AU) 2022902887

(51) Int. Cl. H04L 9/40; G10L 15/22

(52) U.S. Cl. CPC H04L 63/0407; G10L 15/22; G10L 2015/227

(57) ABSTRACT

The is provided a method of processing communication signals from a sender party, the method includes receiving one or more communication signals indicative of non-acousti c speech signals and/or non-speech signals from the sender party (100) processing the one or more communication signals to determine one or more communication units (102) and associating the one or more communication units with one or more unique digital identifiers (UDIs) (104).

### FIELD OF THE INVENTION

The present application relates to methods of communication and in particular to methods of communication that include non-audible speech and/or non-speech components.

Embodiments of the present invention are particularly adapted for extracting information from soundless signals from an operator or machine. However, it will be appreciated that the invention is applicable in broader contexts and other applications.

### BACKGROUND

Humans communicate predominately using audible speech. Non-speech components such as facial expressions and/or gestures add context to audible speech. Furthermore, the soundless components to speech, such as the motor activity associated with speech, may be harnessed in environments and scenarios where audible speech is difficult to produce, transmit or understand. At present, there are limited ways in efficiently capturing and efficiently transmitting these non-speech components.

Any discussion of the background art throughout the specification should in no way be considered as an admission that such art is widely known or forms part of common general knowledge in the field.

### SUMMARY OF THE INVENTION

In accordance with a first aspect of the present invention, there is provided a method of processing communication signals from a sender party, the method including:
receiving one or more communication signals indicative of non-acoustic speech signals and/or non-speech signals from the sender party;
processing the one or more communication signals to determine one or more communication units representing units of non-acoustic speech and/or non-speech information; and
associating the one or more communication units with one or more unique digital identifiers (UDIs).

In accordance with a second aspect of the present invention, there is provided a method of processing communication signals from a sender party, the method including:
receiving one or more communication signals indicative of non-acoustic speech signals and/or non-speech signals from the sender party; and
processing the one or more communication signals to generate one or more unique digital identifiers (UDIs) that represent one or more communication units.

In one embodiment, the method further includes the step of transmitting the one or more UDIs to one or more receiver parties.

In one embodiment, the method further includes the step of receiving the one or more UDIs from the one or more sender parties.

In one embodiment, the one or more sender parties and the one or more receiver parties are the same party.

In one embodiment, the step of associating the one or more communication units with one or more UDIs includes encryption.

In one embodiment, the method further includes the step of decoding the one or more UDIs to recover some or all of the information in the one or more communication signals.

In one embodiment, the sender party is a machine and/or a virtual machine.

In one embodiment, the one or more receiver parties is a machine and/or a virtual machine.

In one embodiment, the one or more receiver parties is a human.

In one embodiment, the sender party is a human.

In one embodiment, the one or more communication signals include biological signals received from one or more sensors.

In one embodiment, the one or more sensors are located on, in, or near a human's body.

In one embodiment, the one or more sensors are located on, in, or near a user's head and/or neck.

In one embodiment, the step of processing the one or more communication signals includes extracting temporal segments of the one or more communication signals.

In one embodiment, the temporal segments are classified by a classifier algorithm to identify one or more communication units.

In one embodiment, the classifier algorithm performs an association of the UDIs with the one or more communication units.

In one embodiment, the one or more communication units include a whole or part of a word.

In one embodiment, the one or more communication units include one or more phonemes, syllables, consonants or vowels.

In one embodiment, the one or more communication units include a spoken phrase.

In one embodiment, the one or more communication units include a sentence.

In one embodiment, the one or more communication units include a part for, or an entire script.

In one embodiment, the one or more communication units include facial expressions and/or gestures.

In one embodiment, the one or more communication units include salient signal gaps.

In one embodiment, the one or more communication units include prosody.

In one embodiment, the one or more communication units include a combination of speech and/or non-speech units.

In accordance with a third aspect of the present invention, there is provided a method of processing communication signals from a sender party, the method including:
receiving one or more communication signals indicative of non-acoustic speech signals and/or non-speech signals from the sender party;
processing the one or more communication signals to determine one or more communication units representing units of non-acoustic speech and/or non-speech information; and
fusing one or more of the communication units into fused communication units.

In one embodiment, the one or more communication signals are electrical signals.

In one embodiment, the one or more communications signals are biologically generated.

In one embodiment, the one or more communications signals are machine derived.

In one embodiment, the method further includes the step of transmitting the fused communication units to a receiver party.

In one embodiment, the method further includes the step of associating the one or more communication units or fused communication units with one or more unique digital identifiers (UDIs).

In accordance with a fourth aspect of the present invention, there is provided a method of processing communication signals from a sender party, the method including:
receiving one or more communication signals indicative of non-acoustic speech signals and/or non-speech signals from the sender party;
processing the one or more communication signals to generate one or more unique digital identifiers (UDIs) that represent one or more communication units of non-acoustic speech and/or non-speech information.

In one embodiment, the one or more communication signals are electrical signals.

In one embodiment, the one or more communications signals are biologically generated.

In one embodiment, the one or more communications signals are machine derived.

In one embodiment, the method further includes the step of transmitting the one or more UDIs to a receiver party.

In one embodiment, the method further includes the step of associating the one or more UDIs representing the one or more communication units with one or more UDIs that represent one or more fused communication units.

In accordance with a fifth aspect of the present invention, there is provided a device for processing signals from a sender party, the device including:
at least one input for receiving one or more communication signals indicative of non-acoustic speech signals and/or non-speech signals from the sender party;
a processor for:
   processing the one or more communication signals to generate one or more unique digital identifiers (UDIs) that represent one or more communication units of non-acoustic speech and/or non-speech information.

In one embodiment, the processor performs an interim step of processing the one or more communication signals to determine one or more communication units representing units of non-acoustic speech and/or non-speech information, then associating the one or more communication units with one or more unique digital identifiers (UDI).

In one embodiment, the processor further includes the step of:
fusing the one or more communication units into fused communication units.

In one embodiment, the device includes at least one sensor for receiving the non-acoustic speech signals and/or non-speech signals from the sender party.

In one embodiment, the device includes a transceiver for transmitting the one or more UDIs to one or more receiver parties.

In one embodiment, the transceiver is configured to receive UDIs from one or more sender parties.

In one embodiment, the transceiver is configured to receive non-UDI signals from one or more sender parties.

In one embodiment, the transceiver is configured to receive non-UDI signals from one or more receiver parties.

In one embodiment, the sender party and receiver party are the same party.

In accordance with a sixth aspect of the present invention, there is provided system for processing signals to and/or from one or more sender parties, the system including:
a sender component including:
   a sender component input for receiving one or more communication signals from the one or more sender parties;
a processor component:
   for processing communication signals to generate one or more outputs that represent the one or more sender parties intended communication; and
   wherein the processor component includes one or more processors which are located on a device of the one or more sender parties, a recipient's device, a third-party device, a cloud platform, or a combination thereof; and
   wherein a processor input of the one or more processors is received directly from a sender's device, via a peer-to-peer connection, through a cloud platform, or a combination thereof; and
a receiver component including:
   a receiver component input for receiving processor outputs that communicates a meaning or instruction behind the one or more communication signals from the one or more sender parties; and
   an interface for a recipient party to receive the processor outputs in a format that communicates the senders intended communication.

In one embodiment, information exchanged between sender/processor/receiver components may include one or more UDIs, non-UDIs, raw signals, and/or data representing text, audio, visual, or tactile information.

In one embodiment, data exchange between one or more components may use a transceiver that may be wired or wireless transmission.

Embodiments of the present invention provide a sound-independent way to communicate all these natural speech and non-speech components. Thus, embodiments of the invention allow for prosody, facial expressions and/or gestures to add context to speech communication by adding appropriate intonation, stress, rhythm and/or emojis, such as happy and sad faces, tongue poking etc., to provide a more complete communication experience. Furthermore, embodiments of the invention use speech and facial expressions/gestures to provide control commands and signals. Examples include speaking commands to a device, and using facial gestures, such as winking left and right eyes for providing instructions to raise or lower, respectively, the volume of a device.

### BRIEF DESCRIPTION OF THE FIGURES

Example embodiments of the disclosure will now be described, by way of example only, with reference to the accompanying drawings in which:

FIG. 1 shows a flow chart in accordance with an embodiment of the invention;

FIG. 2 shows a further flow chart in accordance with an embodiment of the invention;

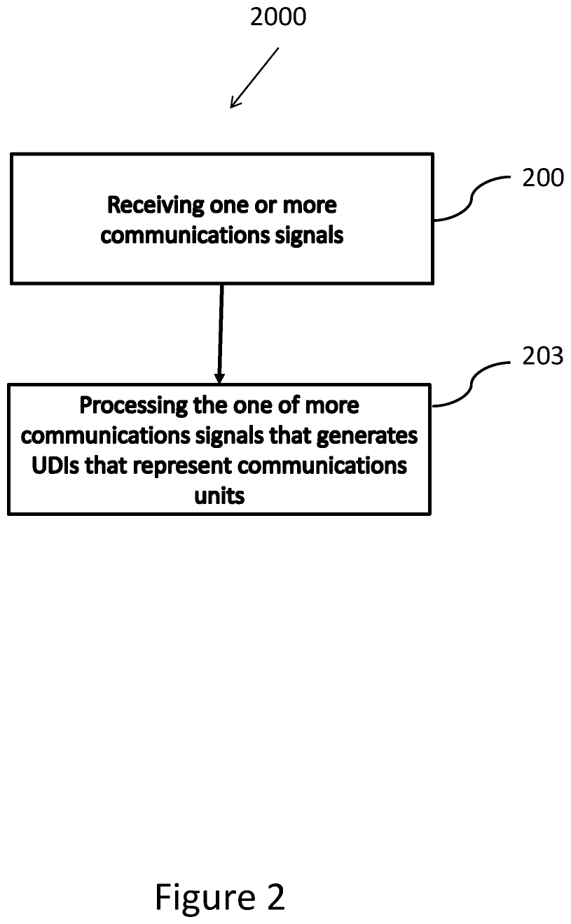

FIG. 3 shows a further flow chart in accordance with an embodiment of the invention;

FIG. 4 shows a further flow chart in accordance with an embodiment of the invention;

FIG. 5 shows a device for processing signals from a sender party in accordance with an embodiment of the present invention;

FIG. 6 shows a system for one user with sending and receiving components shown in accordance with an embodiment of the present invention;

FIG. 7 shows a flowchart of a UDI stream being sent and received, then how it is interpreted at the recipient end in accordance with an embodiment of the present invention;

FIG. 8 shows a flow chart of multiple interfaces in combination with the encoding/decoding of UDIs;

FIG. 9 shows an embodiment of the invention utilizing an avatar of machines and/or virtual entities; and

FIG. 10 shows an embodiment of the invention including a wearable component.

### DESCRIPTION OF THE INVENTION

### Method Overview

In the following description the term “Communications Unit” is used to represent a unit of information relating to a communication of a party (person or machine). A communication unit is taken to encompass any of the following: a speech unit, a non-speech unit and/or a unit of fused communication. A unit of “fused communication” may include the fusion of two or more speech units, the fusion of two or more non-speech units, or the fusion of one or more speech units with one or more non-speech units. Fused communication units also include different states of a speech unit before any fusion step. Each communication unit may be transformed into one or more values or forms of information (e.g., text, symbols, number, emojis, audio, visual, haptic, command signal, programming script, etc.). The communication units are encoded such that they are identifiable to one or more parties through a communication process. A single communication unit may be extracted from one or more inputs, sensor signals or data streams. By way of example, a communication unit may be extracted which represents a combination of data segments of different sensor signals that are indicative of a communication action by a user (e.g. body language movement).

In the following description the term “Unique Digital Identifier (UDI)” is taken to encompass a digital representation for speech and/or non-speech components of the communication. In particular, a UDI is a unique value or identifier that uniquely represents one or more communication units such that those one or more communication units can be identified and decoded by a receiver party. UDIs may be encrypted such that encrypted versions of their values are transmitted. A UDI may be realised in the form of a binary code such as an x-bit binary code or using alphanumeric code as a couple of examples.

In the following description the term “Biological Signals” refers to biological information, including anatomical and/or physiological, related to a person or animal. In some embodiments, biological information is taken, but not limited, to include electrical and mechanical signals or changes in these signals, in the person or animal, such as in the head and neck region during communication. Included in this definition is the positioning of anatomical structures, such as the lower jaw relative to the upper jaw etc.

The present invention relates to the extraction of information from non-acoustic speech/on-speech or soundless signals such as mechanical and/or electrical changes, from the muscles of facial expression, speech articulators (the muscles in the head and/or neck that shape vocalization into components of speech, such as the tongue and lips), and/or phonation generators (i.e. muscles controlling vocal cords). These non-acoustic/non-speech or soundless signals may be extracted from an entity which may include a person or an object. In the case that the entity is a person, these signals may be acquired from the head and neck of the person and encoded into a unique digital identifier (UDI) that represents the speech and/or non-speech components of the communication. Alternatively, in the case where the entity is not a person the signals may be acquired using suitable sensors or transducers.

It is to be understood that in environments where audible sound is either unclear, undesirable, not possible or inappropriate, the extraction of these non-acoustic speech/non-speech or soundless signals is of great value. Examples where the greatest benefit may occur include speech communication under water or in space, stealth conversations (silent speech), the ability to speak in noisy environments where the ambient noise overrides normal speech, voice conversion or avatar applications such as for gaming, language translation and device/robot control among other things.

The present invention augments digitally transmitted non-acoustic speech communication by adding other communication components such as prosody, and facial expressions and/or gestures, thereby adding additional contextual cues and dimensions of communication to provide a more natural, human communication experience. The exchange of UDIs in communication transmission is also very efficient; rather than send a compressed audio file or text characters, one or few UDIs could represent a speech unit or instructions of any length (entire word, phrase, sentence, script etc). This is ideal for applications where data transmission is limited or restricted.

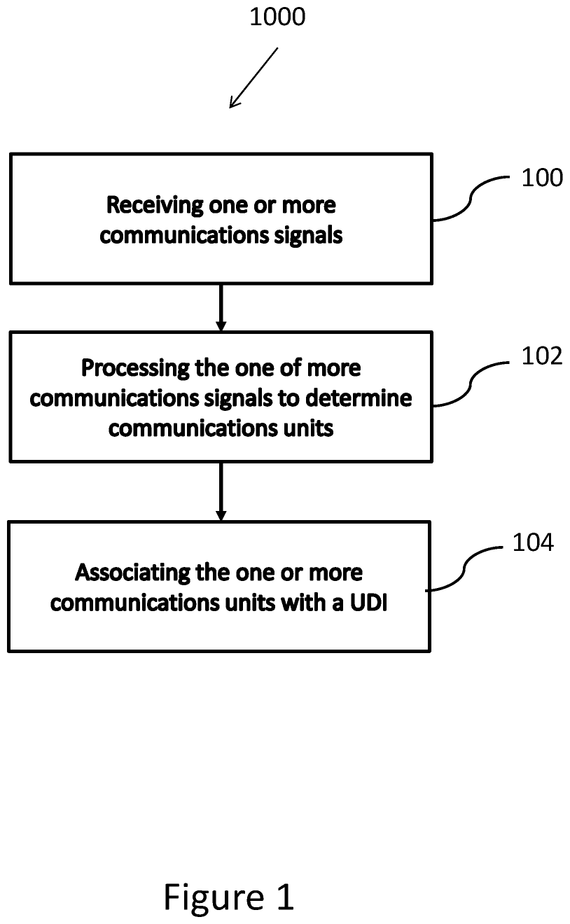

FIG. 1 shows a flow chart which depicts a method of processing communications signals 1000 in accordance with an embodiment of the present invention. The method 1000 may be performed by a processor such as a conventional processor included in a computing device, a microprocessor, a system-on chip device, server, collection of processors or virtual machine. In the initial step 100, one or more communications signals, which may be indicative of either non-acoustic speech signals and/or non-speech or other communication signals, are received from a sender party. In order to receive the one or more communications signals, one or more sensors are used which may receive a variety of mechanical or electrical signals generated by a sender or other entity. The sensors may include a piezo electric crystal, an electrode, a microphone, CCD or other image-capture devices.

The communications signals essentially include information, which is not limited to, soundless signals. By way of example, the communications signals may include mechanical and/or electrical changes, as measured by sensors, from the position of anatomical structures such as points of reference on the skin or muscles of facial expression, speech articulators (the muscles in the head that shape vocalization into the components of speech such as the tongue and lips), and/or phonation generators (i.e. muscles controlling vocal cords). In some embodiments, sensors may be adapted to capture the position of structures associated with the lower jaw, such as the chin, relative to structures associated with the upper jaw, such as the surrounding skin covering the maxilla, for example. The communications signals may include time series information and/or spectral domain information. These signals may be received directly from sensors acquired in real-time or near real-time or received from a database of stored signals. The communications signals may be acquired from sensors located in, on or near the head and neck of a person, recognized and encoded into a unique digital identifier (UDI) as will be discussed below. In one embodiment, the one or more communication signals include biological signals received from one or more sensors located in, on, or near a person's body.

The sender party may be a person or any other entity with the ability to transmit information, such as a machine or a virtual machine. Other examples of such an entity may include equipment, devices or machines that have the ability to generate signals that may report sensory information about itself or its environment, including sensory information reporting a state, or streaming sensory information such as haptic, audio or visual information. Where the sender is a human and the communications signals may include biological signals, the communications signals may be extracted using one or more sensors located on, in, or near a user's body, such as the user's head and/or neck.

Once the one or more communications signals have been received 100, the one or more communications signals may undergo an optional step of pre-processing which may include amplification of the communications signal and/or filtering and/or normalisation, for example normalisation of the number of samples, depending on the quality of the communications signal. This step may be skipped if the quality of the signal is sufficient such that this step is not required. This may be determined based on a number of factors such as the signal to noise ratio (SNR) of the communications signal or ambient noise which may affect the quality of the signal.

Once the optional step of pre-processing has been completed or skipped, at step 102, the one or more communications signals are processed in order to determine one or more communications units which represent units of non-acoustic speech and/or non-speech information. In one embodiment, the one or more communication units include a whole or part of a word, or a salient signal gap. The one or more communication units may also include one or more phonemes, syllables, consonants or vowels or a spoken phrase or sentence.

In some embodiments, the one or more communication units include a part of, or an entire script, facial expressions and/or gestures, salient signal gaps, prosody or a combination of speech and/or non-speech units.

The step of processing the one or more communications signals 102 to determine one or more communications units may involve the process of dividing the one or more communications signals into temporal segments, such as based on a time interval, salient signal gaps, cadence, or other features of the signal. The communication signal, or parts thereof, may have optional signal processing steps, which may include signal normalisation or signal resampling.

The communication signal, or temporally segmented communication signal, is encoded into one or more UDIs. The UDIs may be associated with recognized communication units (steps 102-104). Alternatively, the UDIs may be assigned directly after receiving the input signal (step 203) using a UDI-assigning algorithm that processes the communication signal, or part thereof, and directly outputs a representative UDI (step 203). One approach to achieve this is for the algorithm to directly output a binary representation (i.e. a UDI) of the inputted signal (embodiment utilising step 203, more steps 300-302). Another approach is for the recognition algorithm to classify the inputted signal into a defined communication unit (step 102), which is subsequently assigned a UDI based on a dictionary of communication unit-UDI pairs (step 104). Another approach is to match the inputted signals to a template signal allocated to each UDI.

The UDI represents, inter alia, speech and/or non-speech components of the communication. The UDIs are sent to and received by a recipient which may be a person or a machine. Upon receipt, the UDI may be converted into one or more appropriate communications mediums depending on the application. These communication mediums could include text, audible speech or a command among other things. The recipient may decode the UDI into the relevant communication medium with a lookup table. The UDI may have one or more representations of the same communication unit, depending on the communication application required. For example, a single UDI representing the word “hello” may be represented with the character string “hello”, and/or an audio file that provides an audible “hello” when played, which are called upon by a recipient device as appropriate.

The transmission of UDIs provides for an efficient means of sending comprehensive and complex information, resulting in a reduction in data being sent to represent the one of more communications signals. For example, a single UDI may represent more than a single word, such as “you are”, “he is”, “she is”, “they are”, etc., or it may represent an entire programming script that executes a series of appropriate functions. Furthermore, the UDI may have multiple output representations of these, such as a text and an equivalent audio version as outlined above.

A single UDI could represent a part of a word (e.g. phoneme or syllables, that can be used to build up words), or a whole word, phrase, an entire sentence or an entire script. A single UDI could represent a non-speech unit, for example as a smile, wink, sad face, frown, eyeroll, etc. A single UDI could represent a speech contextual cue, for example such as a prosodic intonation. A single UDI could represent fused communication units, such as a speech unit fused with a contextual cue (e.g. “hellooo”), a speech unit fused with a non-speech unit, such as a word that is accompanied with a facial expression (e.g. “hello <wink>”), or a contextual cue fused with a non-speech unit (e.g. “<smiile>”), or fusion of speech, contextual cue, and non-speech (e.g. “hellooo <wink>”).

In one embodiment, the UDI may be an x-bit binary number or binary sequence where, x is chosen based on the number of UDIs required to represent an entire dictionary of speech and/or non-speech components. For example, a system with 16-bit (i.e. x=16) binary representation of UDIs would permit 2¹⁶ communication units to be expressed, with each UDI being a unique sequence of 16 zeros and ones. A UDI may also include multiple UDIs, for example where multiple UDIs are referred to by a multi-label classifier system. e.g. [1,0,0] vs [1, 1,0] could represent the presence and absence of 3 UDIs.

In one embodiment, the method includes the step of transmitting the one or more UDIs to one or more receiver parties, alternatively the sender party and receiver party may be the same party. In some embodiments, the sender party may be a human, machine or virtual machine.

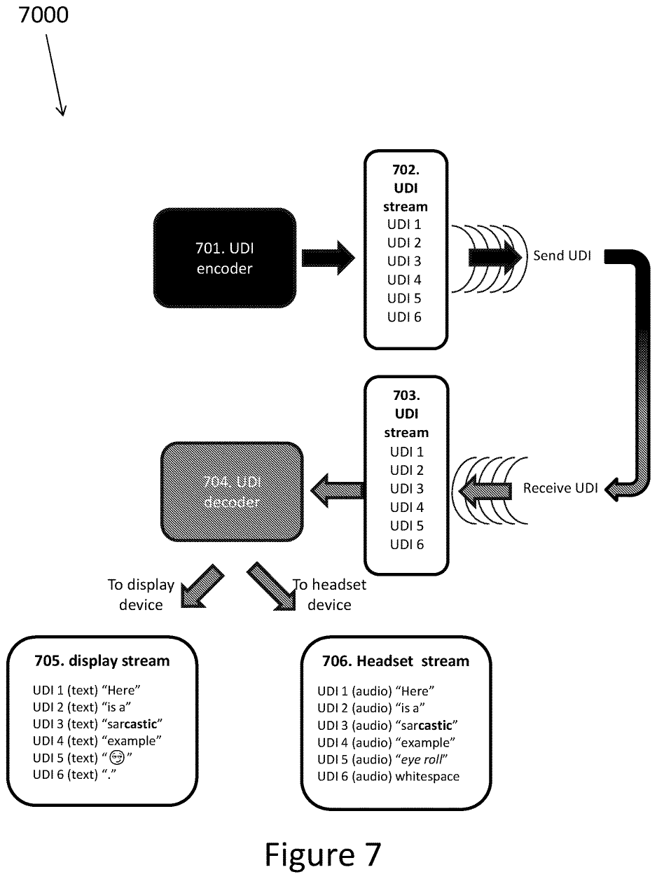

In this case, the UDI is sent to, and received by, a recipient UDI decoder, where it is converted into one or more appropriate communication mediums depending on the application (e.g., these could include text, audible speech, a command, etc., FIG. 7) as will be discussed below. In some embodiments, the receiver party may be a human, machine and/or virtual machine.

Once the UDI has been transmitted and received by a receiver party, the step of decoding the one or more UDIs to recover some or all of the information in the one or more communication signals may be performed. This decoding may be achieved using a decoding algorithm or a look-up table where the UDI is associated with the communication unit to be expressed.

In one embodiment, the step of associating the one or more communication units with one or more UDIs includes encryption. The method of encryption may include Advanced Encryption Standard (AES), Rivest-Shamir-Adleman (RSA) or Data Encryption Standard (DES) encryption algorithms as a few examples.

In one embodiment, the step of processing the one or more communication signals includes extracting temporal segments of the one or more communication signals.

In one embodiment, the temporal segments are classified by a classifier algorithm directly into a UDI.

In one embodiment, the temporal segments are classified by a classifier algorithm to identify one or more communication units.

In one embodiment, the classifier algorithm performs an association of the UDIs with the one or more communication units.

In one embodiment the UDI may be generated directly from the captured communication signal (step 200). For example, a UDI-assigning algorithm, that processes the communication signal, or part thereof, may directly output a representative UDI (step 203). One approach to achieve this may be the use of a neural network algorithm that directly outputs a unique binary representation (i.e. a UDI) of the inputted signal (embodiment utilising step 203).

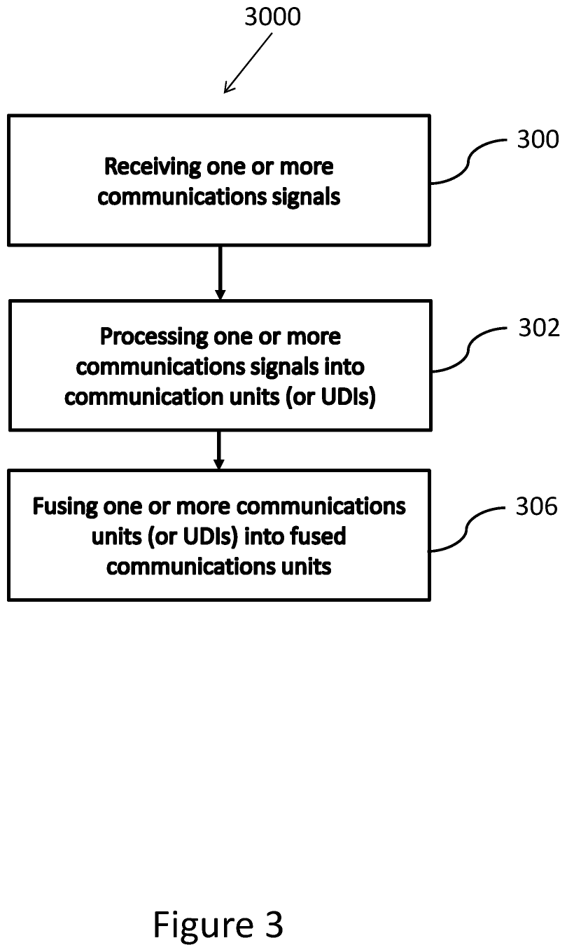

With reference to FIG. 3 a method of processing communications signals from a sender party 3000 in accordance with an embodiment of the invention is shown. The communications signals may include electrical signals, signals that are biologically generated, including mechanical and/or positioning information of biological structures or alternatively signals that are machine derived. The method 3000 includes the step of receiving one or more communication signals indicative of non-acoustic speech signals and/or non-speech signals from the sender party 300. The signals may be received using a number of different sensors such as a piezo electric device, or piezo resistive device, a microphone, CCD or other image capture device, such as time-of-flight (ToF) techniques such as LiDAR, as some examples.

The communications signals may be electrical signals, biologically generated signals, or machine derived signals as some examples.

The step of receiving the one or more communications signals 300, is then followed by the step of processing the one or more communication signals 302 to determine one or more communication units, or directly assign a UDI, that is representative of non-acoustic speech and/or non-speech information which is followed by the optional step of fusing one or more of the communication units, or UDIs, into fused communication units 306. The step of fusing the one or more communications units 306 may include the blending of non-acoustic speech signals (NASS) with non-speech signals (NSS) as one example. Once the fused communications units have been generated, they may then be sent to a receiver party. Alternatively, the fused communications unit may be directly decoded into a UDI as a single first step. For example, one UDI might directly represent a speech unit with a <smile> non-speech unity, and another UDI might represent the same speech unit with a <frown>.

In one embodiment, the method includes the step of associating the one or more communication units or fused communication units with one or more unique digital identifiers (UDIs).

In one embodiment, the method includes the step of sending one or more communication units to be fused by the recipient (e.g. as unique digital identifiers), and the recipient device fuses the intended communication units.

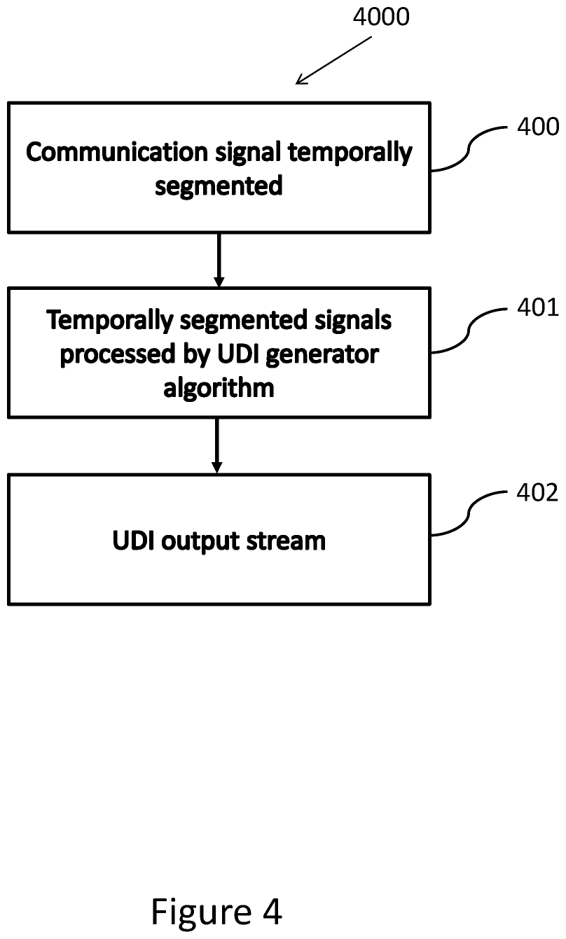

FIG. 4 shows a method comprising the steps of temporally segmenting the communications signals 400, processing the temporally segmented signals processed by UDI generator algorithm 401 and providing a UDI output stream 402 as a result.

### Device Overview

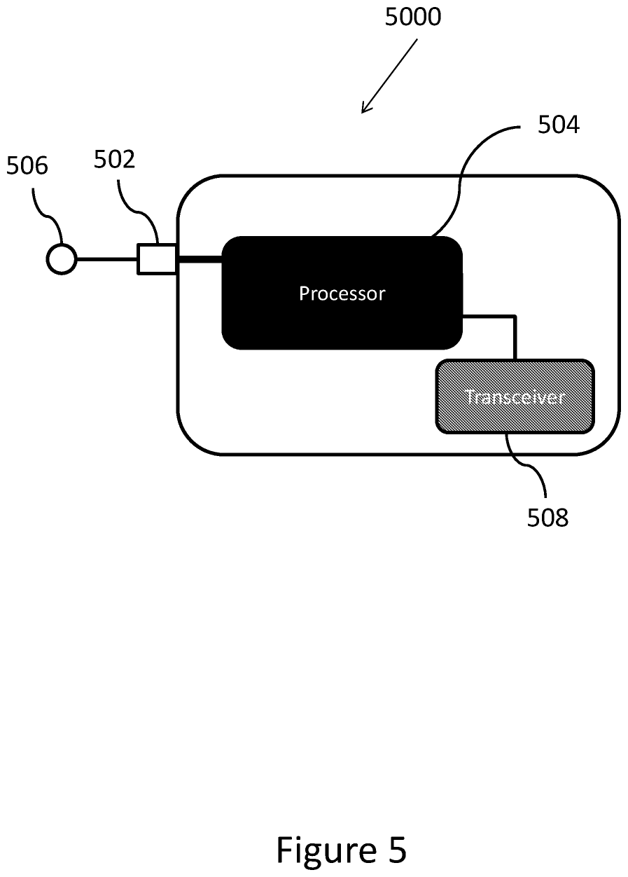

With reference to FIG. 5 there is shown a device 5000 for processing signals from a sender party in accordance with an embodiment of the present invention. The device 5000 includes at least one input 502 for receiving one or more communication signals indicative of non-acoustic speech signals and/or non-speech signals from the sender party. The device 5000 further includes a processor 504 for processing the one or more communication signals to generate one or more unique digital identifiers (UDIs) that are associated with one or more communication units. In one embodiment, the processor 504 is further adapted to fuse the one or more communications units into fused communications units.

In one embodiment, the device 5000 includes at least one sensor 506 for receiving the non-acoustic speech signals and/or non-speech signals from the sender party, and at least one sensor 506 interfacing with at least one input 502.

In one embodiment, the device further includes a transceiver 508 for transmitting and/or receiving the one or more UDIs to one or more parties. In other embodiments the transceiver is configured to transmit and/or receive non-UDI signals. Both the sender part and the receiver party may be the same or may be different parties.

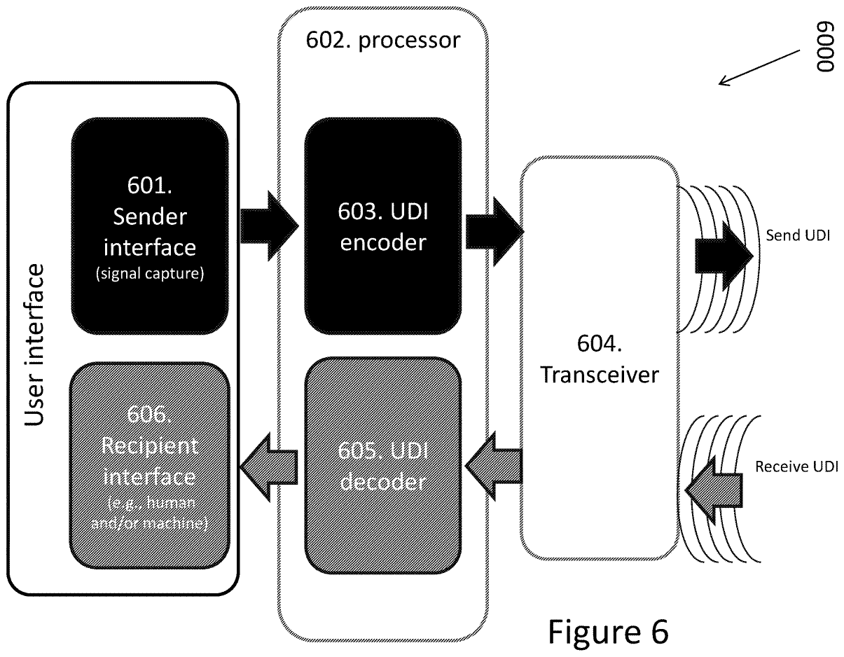

FIG. 6 shows an embodiment of the invention as a device worn by a user 6000 who can send and receive communications. The device permits two-way communication as indicated by the black (sending pathway) and grey (receiving) pathways. Signals are captured from the sender's user interface 601. In the case of a human sender, this may include non-acoustic speech signals (NASS) and/or non-speech signals (NSS) captured from the head and neck. After some optional pre-processing (e.g. amplification, filtering, normalisation), signals are sent to the processor 602. The processor implements a UDI encoder algorithm 603 which receives the captured signals from the sender's interface and converts these into a unique digital identifier (UDI). As an example, a wearable device may send raw signals to a smartphone that will generate UDIs on board that will be sent to a Large Language Model (LLM) in the cloud to be converted into sentences. The sentences are then sent back to the recipient device.

The UDI is then sent to the transceiver 604 for transmission to a recipient. The transceiver 604 permits 2-way communication between the sender and the recipient, and interfaces between the processor and the outside world to send and receive UDIs according to the direction of communication. A recipient receives one, or a stream of UDIs, via the transceiver 604. The incoming UDIs are decoded by a processor using a UDI decoding algorithm or lookup table 605.

The system 6000 further includes a transceiver 604 for transmitting and receiving the one or more UDIs to and from one or more parties, such that two-way communication is permitted among a group of senders and receivers. The system includes a processor 602 which is adapted to process the sender's signals, generate appropriate UDIs for sending, and management the sending the UDIs to one or more intended recipients. The system also includes a processor 602 which is capable of receiving UDIs from one or more parties, and generate an interpretation of the meaning behind the non-acoustic speech signals and/or non-speech signals from the one or more individuals of the communication party.

The UDI decoder converts UDIs into an output format appropriate for the recipient and/or application, which is provided to the recipient's interface 606. For example, if the recipient is another human user, it may receive audio as speech via bone conducting headphones, or if the recipient is a machine, it may receive instructions as a script or a command signal.

FIG. 7 exemplifies a system for unique digital identifier (UDI) encoding and decoding 7000. The processing unit performs UDI encoding and decoding. The UDI encoder 701 generates a stream of UDIs 702 generated from non-acoustic speech signals (NASS) and/or non-speech signals (NSS) 4000. The UDIs are sent, then received 703 by a recipient device.

The UDI decoder of the recipient device 704 decodes the UDI stream into the appropriate output for the application. Shown in FIG. 7 are two outputs; the first example is text which is sent to a display device, and the second example is audio, which is sent to a headset device, such as an audio headset. The UDI stream is converted into a stream of text 705 and audio 706 which are displayed and played, respectively, on the recipient's interface devices.

The example speech output demonstrates prosody expression shown as bold text to indicate stress (705 and 706) and italics to indicate the audio version of the emoji 706 which is delivered in a narrating commentary voice to distinguish it from the main speech output.

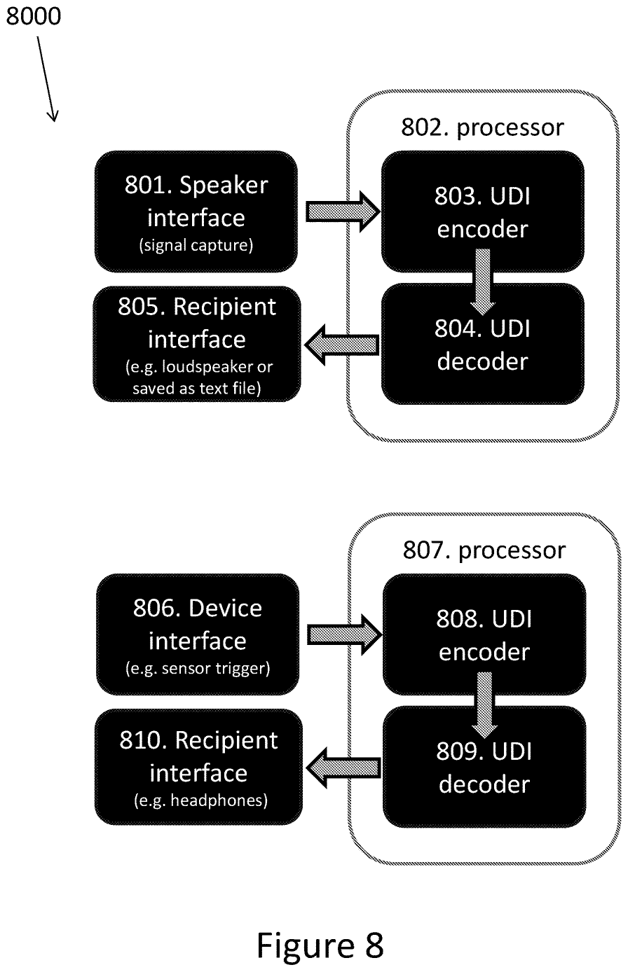

FIG. 8 exemplifies one-way communication systems 8000 as indicated by the grey arrows. A. Human-device: NASS and/or NSS are captured from the head and neck of a person speaking 801. Example scenarios include a speaker who lost the use of their larynx, a speaker wishing to translate into another language, a speaker dictating, or sending commands to a computer.

With reference to FIG. 8, after some optional pre-processing (e.g. amplification and filtering), captured signals (e.g., NASS and/or NSS) are sent to the processor 802. The processor implements algorithms to encode the speech and/or non-speech content into UDIs 803, and subsequently decode the UDIs into the appropriate output format for the application 804 before it is sent to the recipient interface 805.

Device-human: signals from a device may be generated from sensors or device processors 806. An example may include a device that reports the status of critical information, such as gas levels in a diver's tank. The signals are sent to the processor 807 that encodes the signals into a UDI 808, then transforms these into the appropriate output by the UDI decoder 809, before being sent to a human interface for the recipient to receive the message in an appropriate format 810.

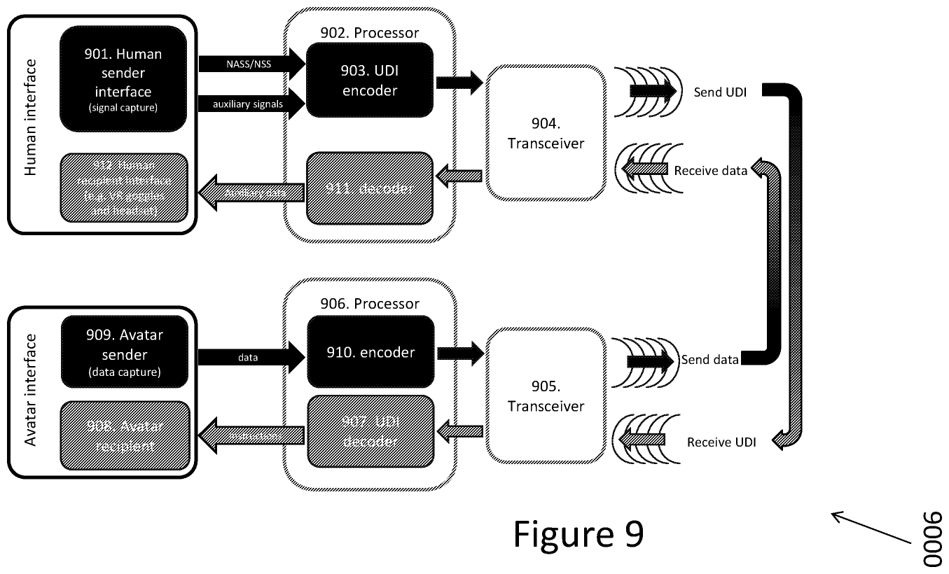

FIG. 9 shows a system 9000 in accordance with an embodiment of the invention. In the embodiment shown, two-way communication is permitted as indicated by the black (sending pathway) and grey (receiving) pathways between a human and an avatar (i.e. a robot, drone, machine, device, autonomous vehicle/machine, virtual entity etc.). Signals are captured from a human sender 901, this may include non-acoustic speech signals (NASS) and/or non-speech signals (NSS) captured from the head and neck, and/or additional (auxiliary) signal(s), such as other non-speech biological signals, eye-tracking, accelerometer, gyroscope or other signals, or a combination of signal types. After some optional pre-processing (e.g. amplification, filtering and normalisation), signals are sent to the processor 902.

The processor implements algorithms which include a UDI encoder 903 that receives the captured signals (e.g., NASS/NSS/auxiliary signals) and converts these into instructions (command signals and/or scripts) encoded into one or more unique digital identifiers (UDIs). The UDIs are subsequently sent to the transceiver 904 for transmission to the avatar, which are received by the avatar's transceiver 905. These wired or wireless transceivers permit 2-way communication between the human and the avatar, and interface between each respective processor and the outside world to send and receive UDIs and/or other data according to the direction of communication.

The avatar's processor 906 receives the UDIs which it decodes into the instructions 907 that are sent to the avatar to execute 908. Whilst receiving and executing instructions/commands, the avatar may also simultaneously capture and/or generate new data 909 for processing 906 and transmission 905 to the human participant. Depending on the nature of the avatar's captured and/or generated data (e.g., speech and/or audio/visual data), the processor may execute one or more encoding algorithms 910 as governed appropriate for the data and the application. Thus, the encoding algorithms may include UDI encoding for speech generation, and/or standard encoding algorithms (for audio/visual data), as needed. The packaged avatar data is sent and received by the avatar's 905 and human's 904 transceivers respectively, passed to, and decoded 911 by, the human device's processor 902 and send to the human interface/s 912 as appropriate for presenting the auxiliary data to the human user in a format that allows a smooth interface with the avatar, such as virtual or augmented reality goggles and/or a bone conducting headset.

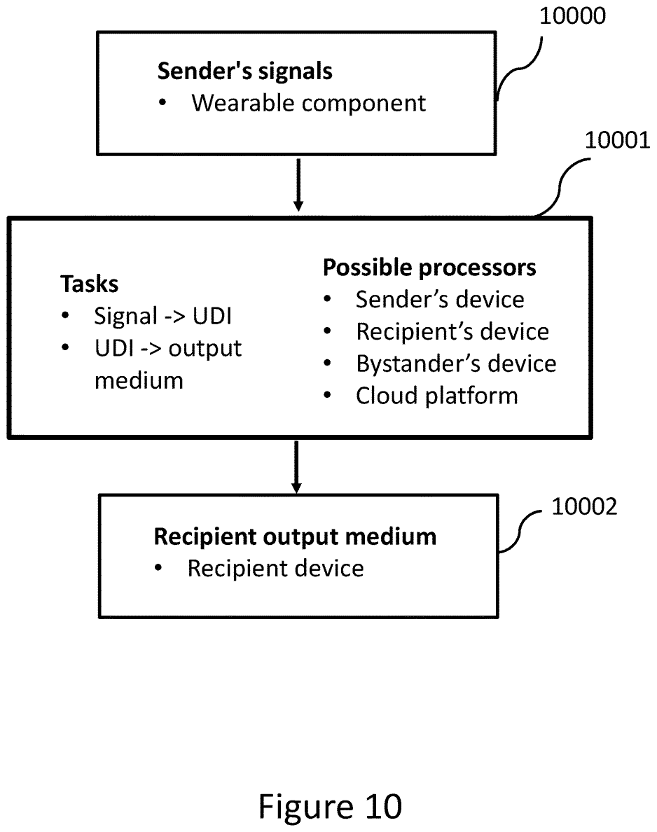

FIG. 10 shows another embodiment of the invention with a wearable component that interfaces with more conventional and ubiquitous communication systems, such as smartphones or cloud infrastructures.

The wearable device is designed to be worn on the user's body. One or more integrated sensors actively captures biological signals 10000 generated by the user. These biological signals could be electrical, mechanical, and/or related to the position of anatomical structures such as skin, bone and muscle of the user, or a combination of signal types. The wearable device digitises the one or more signals and sends them wirelessly (e.g. via Bluetooth or WiFi) to a processor 10001 (e.g. on a smartphone or a cloud platform).

The one or more processors 10001 converts the incoming digitised signals into a UDI then subsequently converts the UDIs into the intended medium for the recipient, which could manifest for example as text, audible speech, visual cues, or other predefined output formats. The one or more processors could include, or be a combination of, a sender's local processor (e.g. a smartphone or wearable device), a cloud-based processor that connects to the sender's device, or a recipient's processor, or a processor located on a 3rd party, such as a bystander's device.

The tasks of encoding, decoding UDIs and converting decoded UDIs into the appropriate medium intended for the recipient may occur on any of the mentioned processors. These tasks could be dedicated to certain processors, or the processors may share the tasks in a distributed arrangement, or a combination of approaches. The communication between one or more processors may be wireless or a physical connection.

An embodiment may include the recipient's device 10002 receiving the sender signals, or UDIs, directly from the sender's device, or via a peer-to-peer connection, or through the cloud platform, or a combination of these. The recipient's device could perform the tasks requires to convert the signal to the intended output medium, or it may receive the intended output medium from another available processor 10001.

### UDI Concept

One embodiment of the invention involves the generation of UDIs to represent speech (and/or instruction) units i.e., a subset of speech, which could vary in size, include a phoneme, syllable, consonant, word, phrase, sentence, or a script, or a plurality of any of these. The UDI may point to multiple items (outputs) simultaneously, such as audio or text representations of the speech, or other equivalents representing that speech unit. This can be summarised as follows:
Nass->Udi->{audio, Text, Command, . . . }

Note that the audio is not dependent on the text version for its production, but rather, the same UDI has multiple representations (see also 705 and 706 of FIG. 7), and thus audible speech generation is not reliant on any preceding generation of text. Furthermore, irrespective of the final format, transmission from sender to receiver is the same; it is always a sequence of UDIs.

Depending on the application, the appropriate output for that UDI is delivered to the recipient's device. For example, for underwater communication applications, the UDI may point to the audible speech version for diver recipients but may point to the text equivalent for surface recipients who might observe, with a display device (e.g., a screen), or log the underwater conversations.

Another embodiment of the invention involves encoding UDIs that can directly represent speech units, non-speech units, and fused communication units i.e., the combination of speech units with non-speech components. This can be summarised as follows:
UDI->{speech, non-speech, speech & non-speech}

Contextual cues and/or non-speech units include items not normally decoded from non-imaged based NASS, such as prosody and facial expressions and/or gestures. Thus, the UDIs are not limited to representing the speech content, but it may also include contextual cues and non-speech items, or fused items representing the speech plus contextual cues/non-speech items (with a single UDI). For example, two UDIs might represent the same word (or words) but with different prosody where the stress (bolded) occurs at different parts of the speech unit, for example:
UDI-001: “this example”
   and
UDI-002 “this example”

These two examples contain the same speech content represented by two UDIs, i.e., one for each prosody variant. Each UDI has different possible outputs representing this content (e.g., audible speech and text versions) that is called upon appropriately at the recipient device (see FIG. 7 for more examples).

### Interpretation

Unless specifically stated otherwise, as apparent from the following discussions, it is appreciated that throughout the specification discussions utilizing terms such as “processing,” “computing,” “calculating,” “determining”, analysing“ or the like, refer to the action and/or processes of a computer or computing system, or similar electronic computing device, that manipulate and/or transform data represented as physical, such as electronic, quantities into other data similarly represented as physical quantities.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

### Definitions

Non-acoustic speech signals (NASS): a subset of human speech signals acquired via non-acoustic means, such as mechanical (including positional changes of anatomical structures, such as changes of the skin, muscle, or bone) and/or electrical changes of internal and/or external head and neck structures that may include but not limited to those associated with speech phonation, speech articulators, and/or respiration.

Non-speech signals (NSS): Any signal, that is not defined as a NASS, that can eventually be used for communicating between humans, machines, and/or human-machine (or machine-human) in simplex and/or duplex communication. Biological non-speech signals may include items such as prosody, facial expressions and/or gestures, and other such contextual cues, or other signals generated by the body such as head and neck signals not directly related to speech communication. Non-biological non-speech signals, they may include analogue or digital signals, e.g., from a device.

### Communication Signals: Any Speech or Non-speech Signal or Combination.

Speech units: A unit of speech derived from speech and/or NASS, which may include silence (e.g., white spaces and breaks), a phoneme, syllable, consonant or vowel, or any sequence of one or more of these, such as words, phrases, sentences, scripts etc.

Non-speech units: A unit of non-speech derived from NSS. The unit may be a fundamental, non-divisible unit, or a sequence of multiple non-divisible (atomic) units.

Fused communication units: The fusion of two or more speech units, the fusion of two or more non-speech units, or the fusion of one or more speech units with one or more non-speech units. Fused communication units also include different states of a speech unit before any fusion step e.g. “hi<smile>” is a fused communication unit when the speech unit “hi” is captured during a <smile> event, even though there was no post-hoc step to fuse these from separate “hi” and <smile> units.

Communication units: includes any of the following: speech unit, non-speech unit, speech and non-speech, or a fused communication unit.

Unique digital identifier (UDI): a digital key, representing one or more communication units, that has one or more values (e.g., text, symbols, number, emojis, audio, visual, haptic, command signal, programming script, etc).

Machine: includes physical entities, such as a machine, computer, device, robot, avatar, or a non-physical entity, such as a virtual machine, avatar, or any virtual entity.

Biological signals: when used in the context of the specification biological signals refers to biological information, including anatomical and/or physiological, related to a person or animal. In some embodiments, biological information is taken, but not limited, to include electrical or mechanical signals or changes in these signals, in the person or animal, such as in the head and neck region during communication. Included in this definition is the position of anatomical structures, such as skin, muscle and bone, and their positional changes, for example the lower jaw relative to the upper jaw or lip, etc.

In the claims below and the description herein, any one of the terms “comprising”, “comprised of”, or “which comprises”, is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” or “connected” may mean that two or more elements are either in direct physical, electrical, electromagnetic (such as wireless protocols such as WiFi and Bluetooth) or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skilled in the art will realize that additional embodiments can be readily envisioned that are within the scope of the present invention.

1-50. (canceled)

51. A method of processing communication signals from a sender party, the method including:
receiving one or more communication signals indicative of non-acoustic speech signals and/or non-speech signals from the sender party; and
processing the one or more communication signals to generate one or more unique digital identifiers (UDIs) that represent one or more communication units.

52. The method according to claim 51, including the step of transmitting the one or more UDIs to one or more receiver parties and/or including the step of receiving the one or more UDIs from the one or more sender parties.

53. The method according to claim 51, wherein the one or more sender parties and the one or more receiver parties are the same party.

54. The method according to claim 51, including the step of associating the one or more communication units with one or more UDIs, wherein the step further includes encryption.

55. The method according to claim 51, including the step of decoding the one or more UDIs to recover some or all of the information in the one or more communication signals.

56. The method according to claim 51, wherein the sender party is a machine and/or a virtual machine and/or wherein the one or more receiver parties is a machine and/or a virtual machine.

57. The method according to claim 53, wherein the one or more sender and/or receiver parties is a human.

58. The method according to claim 51, wherein the step of processing the one or more communication signals includes extracting temporal segments of the one or more communication signals.

59. The method according to claim 58, wherein the temporal segments are classified by a classifier algorithm to identify one or more communication units.

60. The method of claim 59, wherein the classifier algorithm performs an association of the UDIs with the one or more communication units.

61. The method according to claim 51, wherein the one or more communication units include:
a whole or part of a word;
one or more sub-phonemes, phonemes, syllables, consonants or vowels;
a phrase;
a sentence;
a part for, or an entire script;
facial expressions and/or gestures;
salient signal gaps;
prosody; or
a combination of speech and/or non-speech and/or fused communication units.

62. The method according to claim 51 including the steps of:
receiving one or more communication signals indicative of non-acoustic speech signals and/or non-speech signals from the sender party;
processing the one or more communication signals to determine one or more communication units; and
fusing one or more of the communication units into fused communication units.

63. The method of claim 62, wherein the one or more communication signals include:
electrical or electromagnetic signals;
biological signals received from one or more sensors; or
machine and/or sensor derived signals.

64. The method of claim 62, further including the step of transmitting the fused communication units to a receiver party.

65. The method of claim 62, further including the step of associating the one or more communication units or fused communication units with one or more unique digital identifiers (UDIs).

66. A device for processing signals from a sender party, the device including:
at least one input for receiving one or more communication signals indicative of non-acoustic signals, and/or speech signals and/or non-speech signals from the sender party;
a processor for:
processing the one or more communication signals to generate one or more unique digital identifiers (UDIs) that represent one or more communication units.

67. The device of claim 66, further including the step of:
fusing the one or more communication units into fused communication units.

68. The device according to claim 66, wherein the sender party and receiver party are the same party.

69. A system for processing signals to and/or from one or more sender parties, the system including:
a sender component including:
a sender component input for receiving one or more communication signals from the one or more sender parties;
a processor component:
for processing communication signals to generate one or more outputs that represent the one or more sender parties intended communication;
wherein the processor component includes one or more processors which are located on a device of the one or more sender parties, a recipient's device, a third-party device, a cloud platform, or a combination thereof;
wherein a processor input of the one or more processors is received directly from a sender's device, via a peer-to-peer connection, through a cloud platform, or a combination thereof; and
a receiver component including:
a receiver component input for receiving processor outputs that communicates a meaning or instruction behind the one or more communication signals from the one or more sender parties; and
an interface for a recipient party to receive the processor outputs in a format that communicates the senders intended communication.

70. The system according to claim 69, whereby information exchanged between sender/processor/receiver components may include one or more unique digital identifiers (UDIs), non-UDIs, raw signals, and/or data representing text, audio, visual, or tactile information.
